(19) United States
(12) Patent Application Publication
(10) Pub. No.: US 2012/0061182 A1
(43) Pub. Date: Mar. 15, 2012

(54) Multi-Positional Articulating Hinge with Internal Stops and Remote Actuation and Methods for Manufacturing the Same

(76) Inventor: Ronald R. Grimes, Provo, UT (US)

(21) Appl. No.: 12/878,736

(22) Filed: Sep. 9, 2010

(51) Int. Cl. E05D 11/10; E04G 1/15; E06C 1/28

(52) U.S. Cl. 182/194; 16/332; 182/223

(57) ABSTRACT

An indexing hinge may be used with ladders and the like and provides stops at various indexed locations using radially-moving indexing pins. The indexing structure is contained within the hinge body substantially without projecting elements other than one or more indexing rods used to actuate the internal indexing mechanism.

### BACKGROUND OF THE INVENTION

1. Field of the Invention

The present invention relates to articulating hinges and their method of fabrication. More specifically, the present invention relates to an improved multi-purpose articulating hinge and method of fabrication that has built-in stops and may be actuated remotely.

2. Background and Related Art

Hinges are commonly used for a variety of applications and are of two general types: (1) free rotating hinges, and (2) indexing hinges with pre-determined indexed positions. Free rotating hinges are typically used to separate two objects having a pivotal relationship to each other, such as in the case of stepladders, doors, cupboards or mobile room dividers. Indexing hinges are most typically used to separate the two opposing halves of an articulating stepladder. Stepladders typically comprise two free rotating hinges with separate locking devices (See U.S. Pat. Nos. 4,421,206 and 7,188,706).

Articulating stepladders usually employ a means for indexing the hinge at pre-determined intervals and temporarily locking them in each position until the next time they are indexed. Those skilled in the art have developed mechanisms for both indexing and locking the hinges in the various indexed positions (See U.S. Pat. Nos. 4,182,431 and 4,974,701). The generally accepted means for accomplishing this action consists of a pair of rotating plates with holes in each arranged in matching hole circle diameters. Both plates rotate about a common load bearing center shaft with the bolt circle diameter extending radially from that center. Either a single pin or a multiplicity of pins intersecting matching holes in the two plates provide a means for both indexing the plates with respect to each other and for locking them into place until the pin or pins are extracted from their intersection leaving the plates free to rotate with respect to each other. The pin or pins are typically retractably attached to the outer surface of one plate and intersect the second plate at holes placed at pre-determined radially-displaced locations. A means for extracting the pin or pins from the aforementioned second plate is provided, usually consisting of a knob, handle or push button attached to the said pin or pins.

Although the indexing hinge was a revolution to the ladder industry, there still remains some problems with respect to articulating step ladders. Most prominent among these problems is the fact that the hinges of the prior art have to be actuated at the hinges themselves. This means that taller ladders sometimes have the hinges too far out of reach to be actuated without first laying the ladders on their sides, actuating the hinges and indexing the radial position of the hinge plates before standing the ladder back up in a useable position. This problem is most pronounced where combination step-extension ladders are involved. Those skilled in the art have developed a technique for actuating the hinge from its standing position regardless of the height of the ladder (See U.S. Pat. No. 5,954,157). Herein a cable is employed to mechanically actuate the hinges from within by running the said cable through a system of opposing miniature pulleys thereby pushing an actuator pin to disengage the locking pins from one of the hinge plates and thereby enabling the plates to rotate with respect to each other. The cables are then strung down through the inner ladder rails where a device mounted within the outer rails passes through holes cut in the inner rails and intersects the cables at intervals matching the distance between rungs and pulls the cables down thereby actuating the hinges. One problem with using a cable to actuate these hinges is that cables have a tendency to stretch over a relatively short period of time. Even a small amount of stretch could have a sizeable effect upon the operation of the hinge rendering it inoperable.

An additional problem encountered with articulating ladder hinges of the prior art is the difficulty in keeping foreign materials out of the working mechanisms of the hinges. Mud, paint, sludge or even water can interfere with the proper function and life expectancy of these hinges. Efforts to encase them in some sort of protective covering or shell have been relatively unsuccessful leaving hinges of the prior art totally exposed to the elements.

A further problem encountered with articulating ladder hinges of the prior art is that of interference with surrounding objects. In the case of those hinges that are actuated at the hinge itself, the actuating devices, be they knobs, handles or buttons, are susceptible to interference from outside objects such as wires, branches, cables or strings. These outside objects can get caught under the knobs or other actuation device and hang-up on them. This not only creates a nuisance to those who are handling the ladders that employ said hinges but represents a real danger when the obstacle of interference also transmits electricity. In the case of articulating hinges that are actuated internally, their method for retracting the indexing pins from engagement with one of the hinge plates requires a sizeable amount of space in the direction of their axis. This causes the mechanical portions of the hinges to extend wider than the width of the adjoining side rails and makes them especially susceptible to interference from outside objects.

A still further problem that exists with hinges of the prior art is the presence of “pinch points” in the location of the exterior dead stops. These stops are designed to keep each ladder or other device from either opening beyond 180 degrees or closing beyond 0 degrees. Although these stops are needful in the providing of safety in the restriction of the hinge motion beyond the limits of its desired function, they also create a danger to users whose fingers or hands may be near the limits when the ladder is being opened or closed. In each design there are sections of the hinges that abut against each other to create a positive stop. Unfortunately, these stops are aligned about the periphery of the hinge plates and are exposed to anything that may get in the way of their natural motion.

### BRIEF DESCRIPTION OF THE DRAWINGS

In order that the manner in which the above-cited and other advantages and objects of the invention are obtained, a more particular description of the invention briefly described above will be rendered by reference in specific embodiments thereof which are illustrated in the appended drawings. Understanding that these drawings depict only typical embodiments of the invention and are therefore not to be considered limiting in its scope, the invention will be described with additional specificity and detail through the use of the accompanying drawings in which:

FIG. 1 is an expanded view of one embodiment of an articulating hinge;

FIG. 2A is an internal view of an outer hinge section;

FIG. 2B is a bottom view of an outer hinge section;

FIG. 3A is an internal view of an inner hinge section;

FIG. 3B is a bottom view of an inner hinge section;

FIG. 4 is a perspective view of a rotational disc assembly;

FIG. 5A is a perspective view of a stationary disc assembly;

FIG. 5B is a frontal view of a stationary disc;

FIG. 5C is a perspective view of a pivot assembly comprising a long extension rod and in its extended position;

FIG. 5D is a perspective view of a pivot assembly comprising a short extension rod and in its fully extended position;

FIG. 5E is a perspective view of a pivot assembly comprising a short extension rod and in its retracted position;

FIG. 5F is a perspective view of a pivot assembly comprising a short extension rod and in its un-extended position;

FIG. 5G is a perspective view of the component parts of both a pivot assembly comprising a long rod and a pivot assembly comprising a short rod;

FIG. 6A is a perspective view of an indexing pin sub-assembly;

FIG. 6B is an expanded view of an indexing pin sub-assembly;

FIG. 6C is a perspective view of an indexing pin locator bushing;

FIG. 6E is an expanded sectional view of an indexing pin sub-assembly;

FIG. 6F is a sectional view of an indexing pin-to-hinge sections assembly wherein the indexing pin is engaged with an indexing hole in the outer hinge section;

FIG. 6F is a sectional view of an indexing pin-to-hinge sections assembly wherein the indexing pin is disengaged from the indexing hole in the outer hinge section;

FIG. 7 is a perspective view of a secondary stationary disc assembly;

FIG. 8A is a perspective view of a transfer disc assembly;

FIG. 8B is an expanded view of a lifter roller assembly;

FIG. 8C is a perspective view of a lifter roller assembly;

FIG. 9 is a perspective view of a secondary rotating disc assembly;

FIG. 10 is a sectioned view of an outer hinge sub-assembly;

FIG. 11 is a sectioned view of an inner hinge sub-assembly;

FIG. 12A is a sectioned view of an outer hinge sub-assembly in relation to an inner hinge sub-assembly;

FIG. 12B is a sectioned view of an inner hinge sub-assembly in relation to an outer hinge sub-assembly;

FIG. 12C is a perspective view of a partial articulating hinge;

FIG. 13A is a sectioned view of an assembly of an inner hinge section and an outer hinge section illustrating the positions of the dead stops of each section in their relative positions while the hinge is in the closed position;

FIG. 13B is a sectioned view of an assembly of an inner hinge section and an outer hinge section illustrating the positions of the dead stops of each section in their relative positions while the hinge is in the opened position;

FIG. 14A is an inside perspective view of an alternative embodiment illustrating an outer hinge section comprising dual extended sections;

FIG. 14B is a perspective view of an alternative embodiment illustrating an assembly of an outer hinge section with an inner hinge section, each comprising dual extended sections in the closed position; and

FIG. 14C is a perspective view of an alternative embodiment illustrating an assembly of an outer hinge section with an inner hinge section, each comprising dual extended sections in the opened position.

### DETAILED DESCRIPTION OF EMBODIMENTS OF THE INVENTION

Embodiments of the invention may be best understood by reference to the drawings wherein like parts have like numerals throughout. Although the embodiments and method of manufacture of the present invention discussed herein are discussed with respect to an articulating hinge, it will be appreciated that the structure and method of manufacturing disclosed may be applied to other products employing pivoting indexing devices such as scaffolding or collapsible landing gear for airplanes and helicopters and the like.

Embodiments of the present invention are directed to articulating indexing hinges manufactured from steel, aluminum or high tensile polymeric resins/plastics and the like. The choice of the particular materials employed may be influenced by a variety of traditional factors such as production costs and material availability. For example, in recent years our national community has become aware of the need to preserve our natural resources. Recycling of plastics, glass and metals has created a sizable fluctuation in material costs. However, production costs are generally less for injection molded high tensile plastics than drop-forged or machined metals and are more predictable. Additionally, polymeric resins do not rust, weigh less than competitive materials and do not conduct electricity.

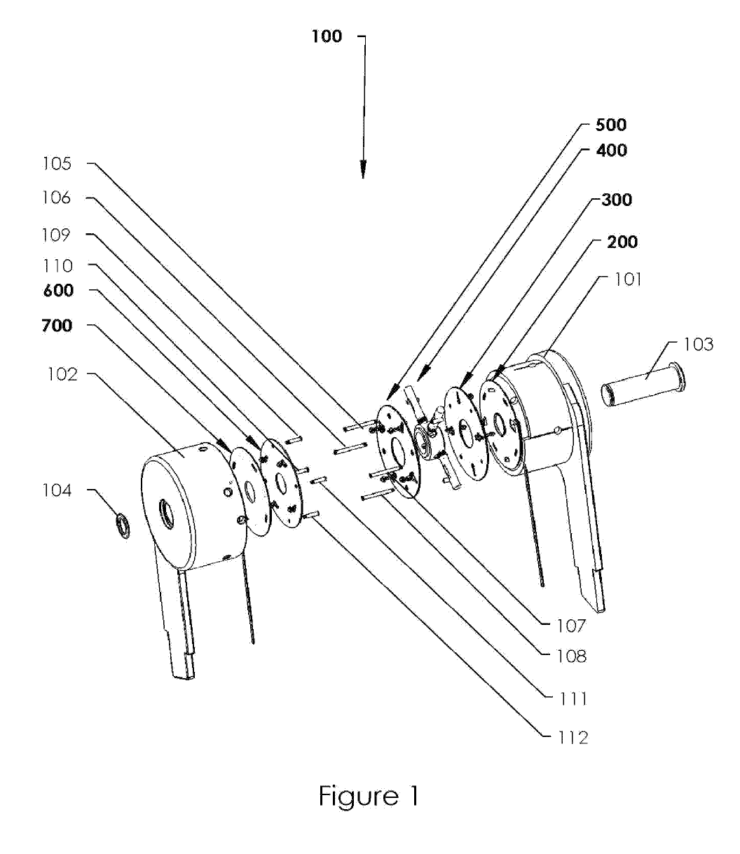

FIG. 1 illustrates a multi-positional articulating hinge, shown generally as 100. Hinge 100 generally comprises an inner hinge section 101, an outer hinge section 102, a master pin 103, a master pin retainer 104, a plurality of inner retaining screws 105, 106, 107 and 108 (herein shown to be four), a multiplicity of outer retaining screws 109, 110, 111 and 112 (herein shown to be four), a primary rotating disc assembly 200, a primary stationary disc assembly 300, an indexing pin assembly 400, a secondary stationary disc assembly 500, a transfer disc assembly 600, and a secondary rotating disc assembly 700.

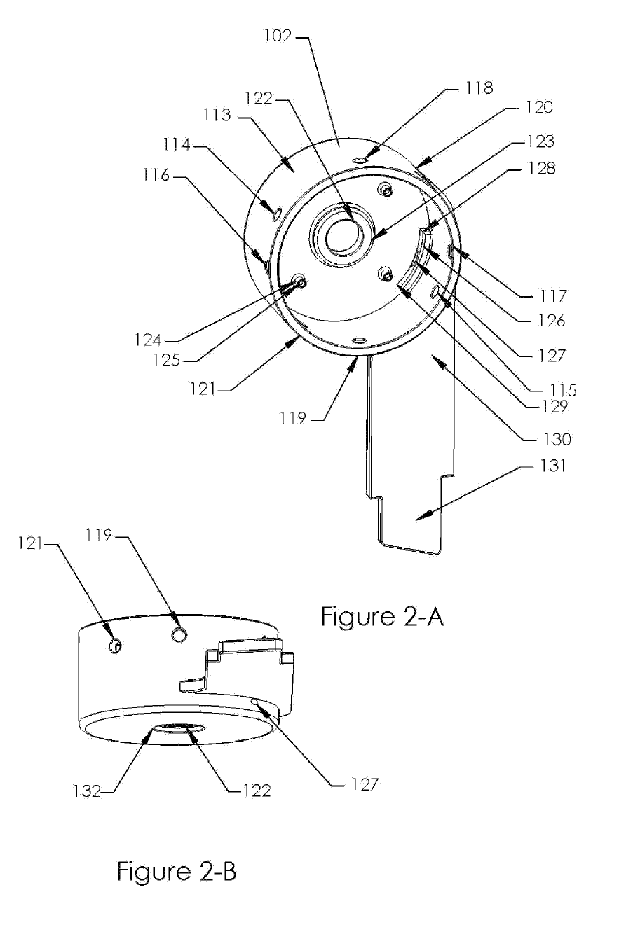

FIG. 2A illustrates an interior view of outer hinge section 102. Outer hinge section 102 is comprised of an outer shell 113, opposing indexing holes 114 and 115, opposing indexing holes 116 and 117, opposing indexing holes 118 and 119, opposing indexing holes 120 and 121, center bore 122, center hub 123, attachment hubs 124 (4-places), interior primary stop 126, indexing rod access hole 127, open interior stop face 128, closed interior stop face 129, outer hinge section extension 130, and rung intercept extension 131. Attachment hubs 124 (shown 4-places) each contain attachment holes 125.

FIG. 2B illustrates a bottom view of outer hinge section 102. In this view indexing rod access hole 127 is shown extending through outer shell 113 and center counter bore 132 is viewed.

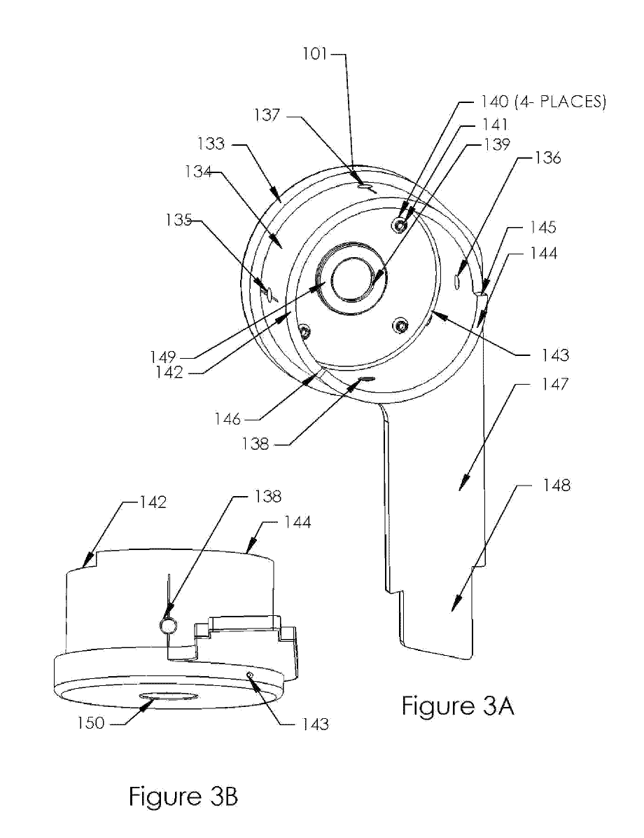

FIG. 3A illustrates an interior view of inner hinge section 101. Inner hinge section 101 is comprised of an outer shell 133, an outer sub-shell 134, opposing indexing holes 135 and 136, opposing indexing holes 137 and 138, center bore 139 and attachment hubs 140 (4-places) each containing attachment holes 141, inner ridge surface 142, outer ridge surface 144, open exterior stop face 145, closed exterior stop face 146, inner hinge extension 147 and rung intercept extension 148. Center bore hub 149 is shown in this view. Also in this view indexing rod access hole 143 is shown.

FIG. 3B illustrates a bottom view of inner hinge section 101. In this view indexing rod access hole 143 is shown extending through outer shell 133 and center counter bore 150 is viewed.

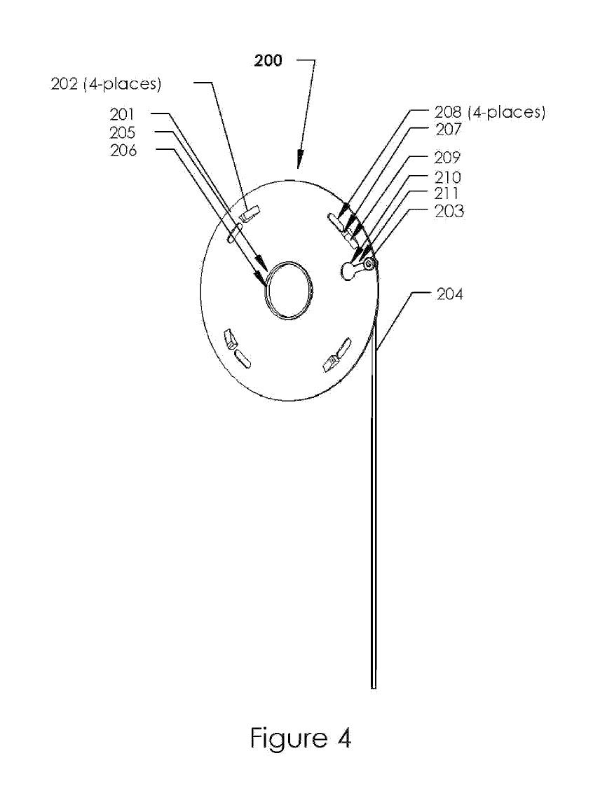

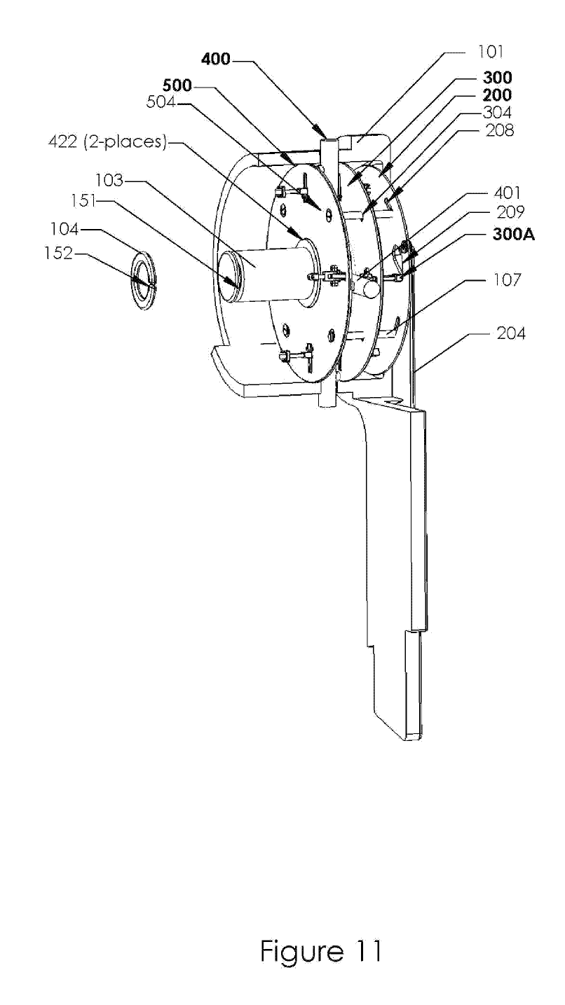

FIG. 4 illustrates a perspective view of a primary rotating disc assembly 200. Rotating disc assembly 200 is comprised of moveable disc 201, lifter ramps 202 (shown 4-places), indexing rod roller 203, indexing rod section 204, stiffening rim 205, center bore 206, lifter ramp plateaus 207 (one each ramp), moveable disc slots 208 (shown 4-places), tapered ramp section 209, indexing rod roller access hole 210 and indexing rod roller slot 211. In this assembly lifter ramps 202 are either formed with or bonded to moveable disc 201 so as to be an integral part thereof. The number and placement of the lifter ramps 202 may vary from that illustrated in FIG. 4 (see, e.g., FIG. 11 for a different placement of the lifter ramps 202) as appropriate or desired, and the number and placement of the lifter ramps 202 shown in FIG. 4 is therefore merely illustrative.

Indexing rod section 204 has one end thereof bent to an approximately or substantially 90-degree angle and inserted into the center hole of indexing rod roller 203. Roller 203 is then aligned with roller access hole 210 and inserted into said roller access hole 210 until a groove formed in the outer periphery of said roller 203 aligns with indexing rod roller slot 211 and is thus rollably engaged thereto. As indexing rod section 204 is moved towards the outer periphery of moveable disc 201, indexing rod roller 203 pivots about the bent end of rod section 204 and rolls across roller slot 211 without disengaging from said slot 211 until the roller 203 is re-aligned with the roller access hole 210.

The extended end of indexing rod section 204 is then passed through indexing rod access hole 127 (see FIG. 2A) from the inside of outer shell 113 and exiting through the outer wall of the same (see FIG. 2B). Master pin 103 (see FIG. 1) is then slidably passed through the center bore 206 of the primary rotating disc assembly 200. Thus, as indexing rod section 204 is pulled downward through indexing rod access hole 127 (FIG. 2A), primary rotating disc assembly 200 pivots freely about master pin 103 (FIG. 1). It should be understood that indexing rod section 204 only represents a small portion of the actual rod. This rod normally extends nearly the length of the inner side rail of an articulating extensible step ladder or crossing members of a scaffold. As the length of these sections vary with respect to the model and size of the item applied to, the length of the indexing rod represented in part by indexing rod 204 will vary proportionally.

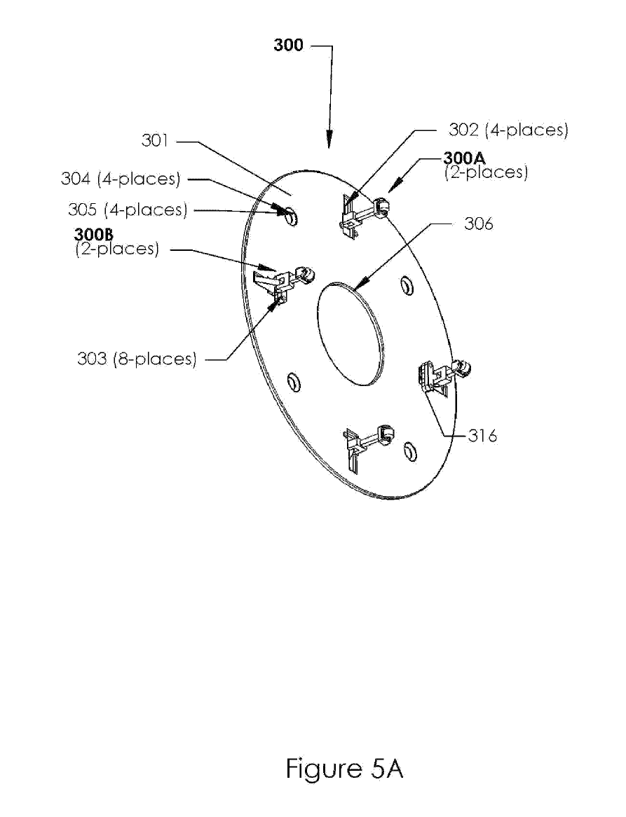

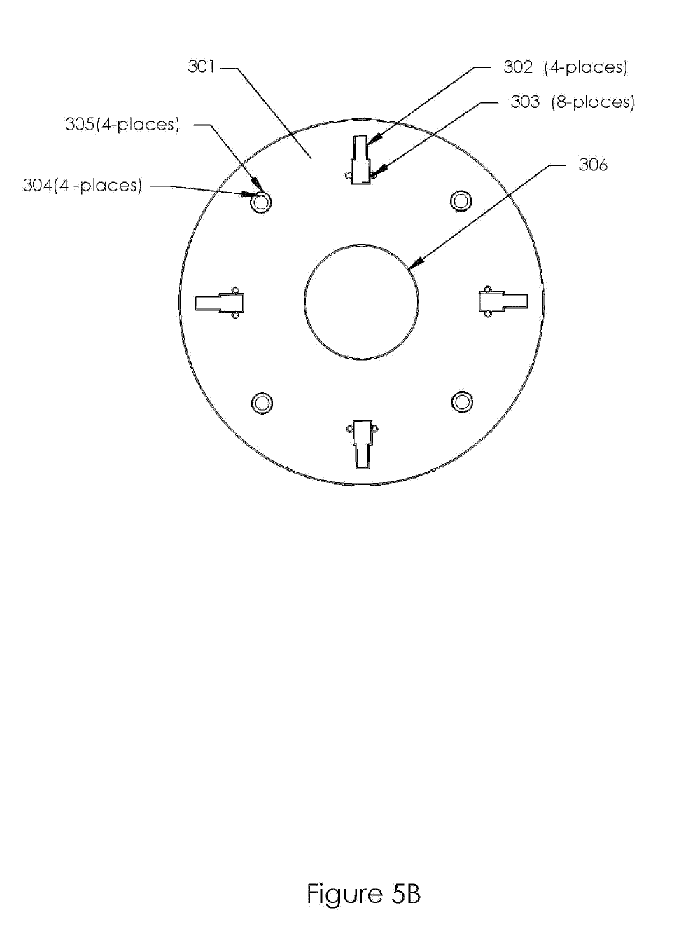

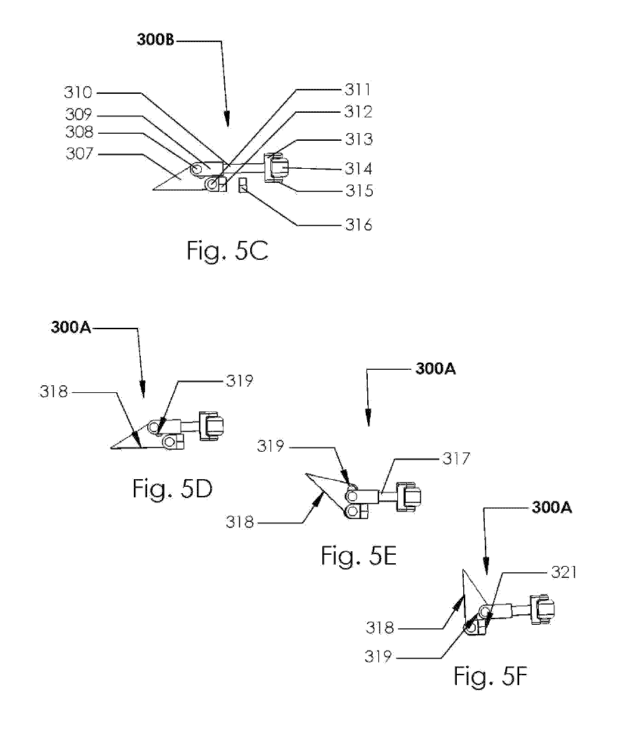

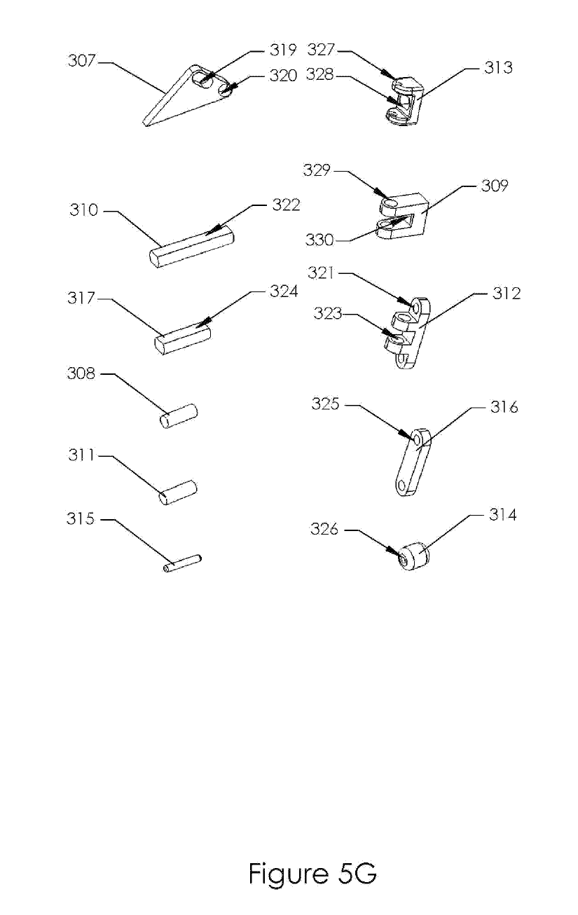

FIG. 5A illustrates a stationary disc assembly 300. Stationary disc assembly 300 comprises primary stationary disc 301, clearance slots 302 (shown 4-places), pivot assembly mounting holes 303, pivot assembly 300A (shown 2-places and more fully described with respect to FIGS. 5D through 5G), pivot assembly 300B (shown 2-places and also more fully described with respect to FIGS. 5D through 5G), mounting holes 304 (shown 4-places), counter sinks 305 (shown 4-places) and center bore 306.

FIG. 5B is a frontal view of primary stationary disc 301 wherein a clearer view of the holes, bores and counter-bores is provided.

FIG. 5C illustrates a side view of pivot assembly 300B. Pivot assembly 300B comprises pivot 307, pivot slide shaft 308, pivot clevis 309, push rod 310, pivot shaft 311, pivot mounting bracket 312, push rod clevis 313, roller 314, roller pin 315 and spacer 316.

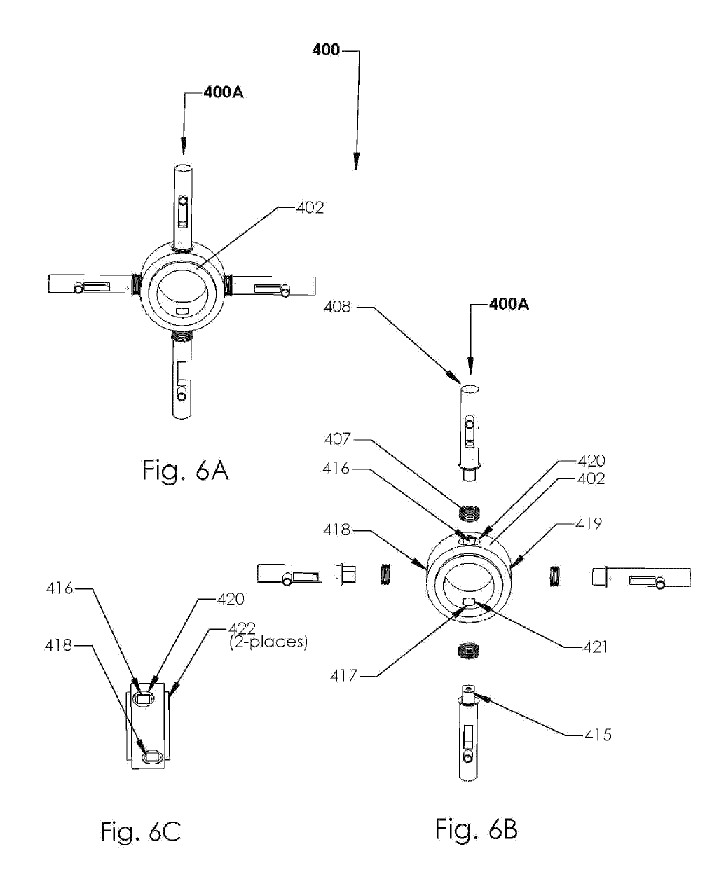

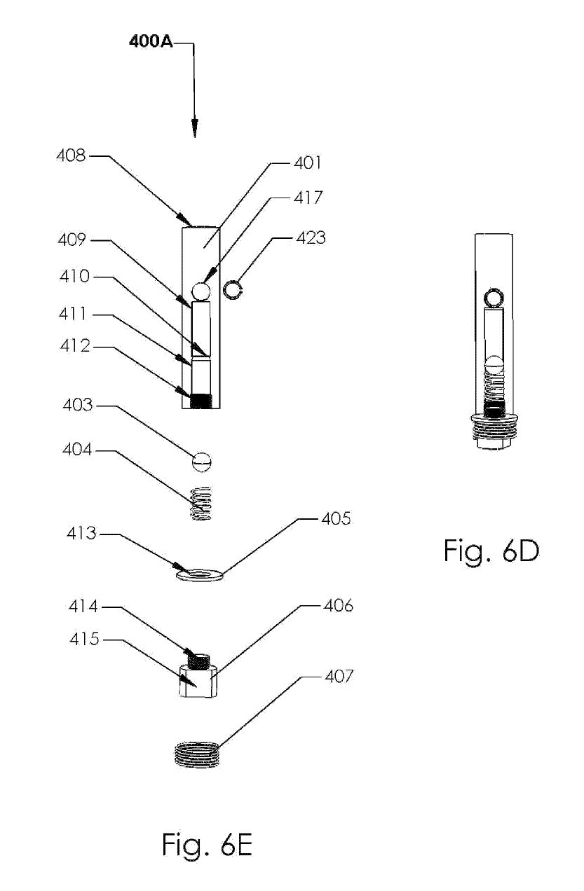

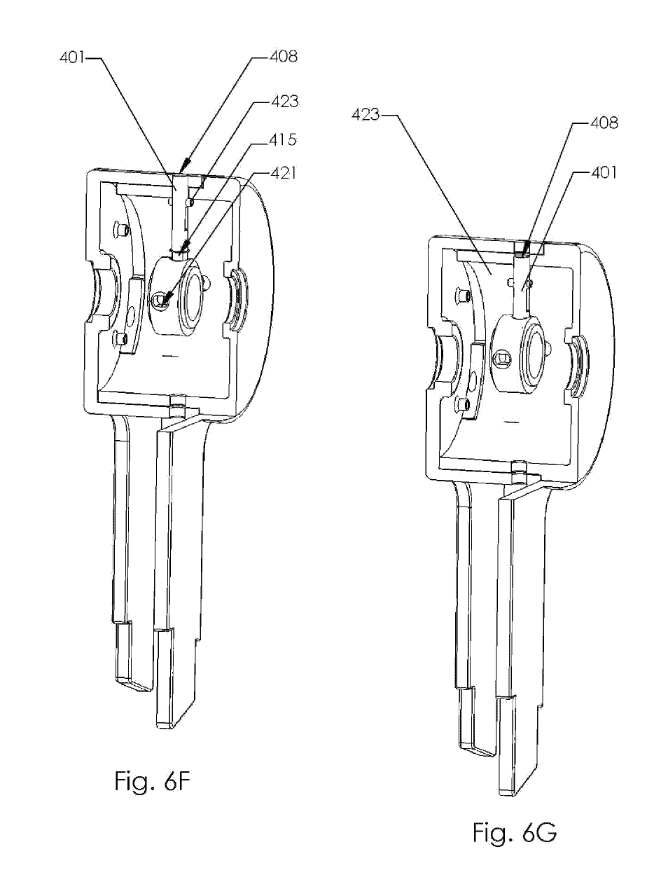

FIGS. 5D, 5E, and 5F illustrate three positional views of pivot assembly 300A. Pivot assembly 300A is identical to pivot assembly 300B with the one exception wherein push rod 310 (see FIG. 5C) is replaced with push rod 317. Push rod 317 is shorter than push rod 310. During the assembly of stationary disc assembly 200 (see FIG. 5A) it will be seen that pivot assembly 300 A (shown 2-places) is mounted on the inner surface of stationary disc 301 whereas pivot assembly 300 B (shown 2-places) is mounted on the outer surface of stationary disc 301. This arrangement enables both pivot assemblies 300A and 300B to protrude from the inner surface of stationary disc 301 to a prescribed distance that corresponds to the difference between bolt circle locating index pin locator holes 416 and 417 (see FIGS. 6B and 6C) from bolt circle locating index pin locator holes 418 and 419. Spacers 316 (see FIGS. 5A, 5C and 5G) may be inserted as needed to acquire a precise location of pivot assemblies 300A and 300B with respect to index pins 401 (shown 4-places) in index pin assembly 400 (see FIGS. 6A and 6B). Extended rods 310 (FIGS. 5C and 5G) allow for rollers 314 (4-shown) to be tangent with the inside surface of moveable disc 201 simultaneously. Also shown herein is pivot pushing surface 318.

FIG. 5D illustrates pivot assembly 300A in a fully extended position. Herein pivot shaft 308 is located at the top of slot 319 of pivot 307. Again, pivot pushing surface 318 is herein shown.

FIG. 5E illustrates pivot assembly 300A in a semi-retracted position. Herein pivot shaft 308 is located at the bottom of slot 319 of pivot 307. Once again, pivot pushing surface 318 is herein shown.

FIG. 5F illustrates pivot assembly 300A in a fully retracted position. Herein pivot shaft 308 is again located at the top of slot 319 of pivot 307.

FIG. 5G illustrates the component parts of pivot assemblies 300A and 300B in more detail. Herein pivot 307 is shown with its included slot 319 and pivot bore 320, extended rod 310 with its included alignment flat 322 (1 of 2 shown), and push rod 317 with its included alignment flat 324 (1 of 2 shown). Also shown is pivot slide shaft 308, pivot shaft 311and roller pin 315. Additionally shown is push rod clevis 313 with its included roller shaft bores 327 and rod receiving hole 328, pivot clevis 309 with its included pivot shaft receiving hole 329 and rod receiving hole 330. Also shown is mounting bracket 312 with its included mounting holes 321 and pivot shaft hole 323, spacer 316 with its included mounting holes 325 and roller 314 with its included roller bore 326.

FIGS. 6A through 6C illustrate three views of indexing pin assembly 400. Indexing pin assembly 400 comprises indexing pin sub-assembly 400A (shown 4-places), return spring 407 (shown 4-places) and hub 402. Herein is shown opposing locator holes 416 and 417 including counter bores 420 and alignment flats 421. Also shown are opposing locator holes 418 and 419 which also include counter bores and alignment flats corresponding to those associated with locator holes 416 and 417. Also shown are hub extensions 422 (shown 2-places). Although four indexing pin sub-assemblies 400A are shown, it should be understood that some embodiments may include more or fewer indexing pin sub-assemblies 400A than shown to modify the indexing positions of the hinge 100 in conjunction with the various indexing holes.

FIG. 6D illustrates a sectional view of indexing pin sub assembly 400A. This Figure shows how the components of indexing pin sub assembly 400A fit together to compose the assembly.

FIG. 6E illustrates an expanded view of the component parts of indexing pin sub-assembly 400A. Indexing pin sub-assembly 400A comprises indexing pin 401, indexing ball 403, indexing ball spring 404, indexing washer 405 with its included indexing washer hole 413, indexing retainer 406 and indexing pin return spring 407. In this view indexing pin 401 is sectioned to reveal indexing pin slot 409, radial intersection point 410, spring channel 411 and indexing pin retainer intersect point 412. Also shown in this view are the indexing retainer threaded area 414 and the indexing retainer flat 415 (1 of 2 shown). Indexing pin sub-assembly 400A is assembled by first inserting indexing ball 403 into spring channel 411, then inserting indexing ball spring 404 into spring channel 411, placing indexing washer 405 on the mating end of indexing retainer 406 and then pressing, screwing or otherwise fixedly attaching retainer 406 to indexing pin 401 at intersect point 412. Care should be taken to align indexing retainer flats 415 with the walls of indexing pin slot 409 so as to make them substantially parallel to each other. Also shown in this Figure are roll pin 423, roll pin hole 417 of indexing pin 401 and indexing pin radial end 408. Roll pin 423 is pressed into roll pin hole 417 until it protrudes approximately evenly from both sides of indexing pin 401.

FIGS. 6F and 6G illustrate the manner in which indexing pin assembly 400A (see FIG. 6B) interfaces with outer hinge section 101 (see FIG. 2A). In FIG. 6G indexing pin 401 is in a retracted position and is thereby disengaged from indexing hole 118 of outer hinge section 102. Outer hinge section 102 is thereby free to rotate about the center axis of the entire assembly. As outer hinge section 102 begins to rotate past hole 118 the retracting force may be released and indexing pin return spring 407 pushes indexing pin assembly 400A outward against the inner wall of outer hinge section 102. As outer hinge section 102 continues to rotate with respect to inner hinge section 101, outer hinge section 102 eventually aligns a separate indexing hole with indexing pin 401 and indexing pin 401 pushes outward thereby engaging with the aligned indexing hole. FIG. 6F illustrates indexing pin 401 in its engaged position with outer hinge section 102. Herein it can be observed that roll pin 423 bottoms out against the inner wall of inner hinge section 101 at a point which causes indexing pin radial end 408 to become at least approximately flush with the outer wall of outer hinge section 102. In this manner roll pin 423 becomes a dead stop against the outward motion of indexing pin assembly 400A.

In an alternate embodiment, the various indexing holes of the outer hinge section 102 may be fashioned such that they do not pass completely through the outer shell 113 so that an outer shell 113 of the outer hinge section 102 is substantially smooth and uninterrupted. Thus, a portion of the material of the outer shell 113, which portion may be relatively thin, may remain substantially unbroken, with each of the various indexing holes penetrating an interior surface of the outer shell 113 a distance less than the total thickness of the outer shell 113. In this configuration, the remaining portion of the outer shell 113 of the outer hinge section 102 serves as a dead stop against the outward motion of the indexing pin assemblies 400A, and the roll pins 423 and roll pin holes 417 discussed above may be omitted in such an embodiment. Thus, while it may be somewhat more difficult to manufacture or fashion the indexing holes in the outer hinge section 102 to not pass completely through the outer shell 113, this additional difficulty may be offset by increased simplicity of manufacturing and assembling the indexing pin assemblies 400A.

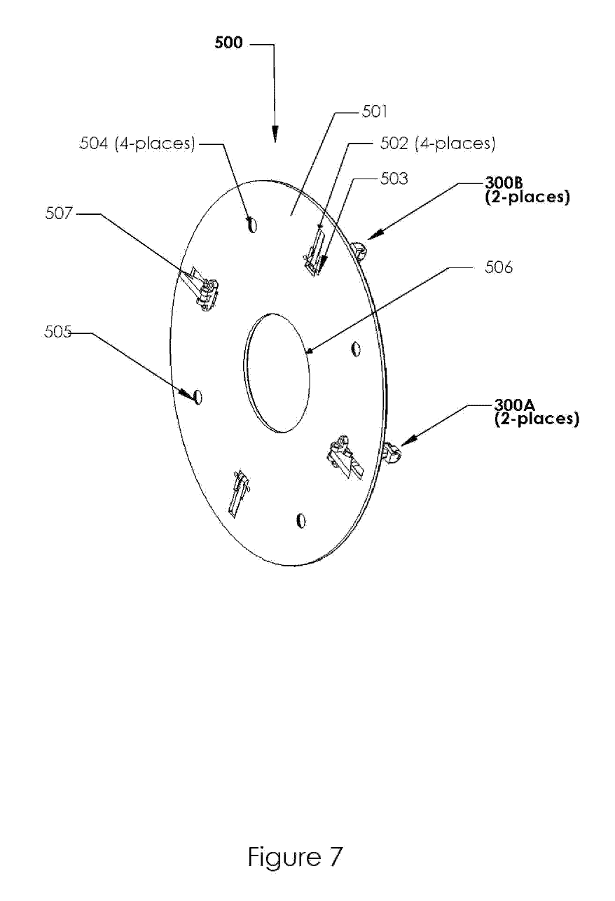

FIG. 7 illustrates a perspective view of secondary stationary disc assembly 500. Secondary stationary disc assembly 500 comprises components similar to and is essentially identical to primary stationary disc assembly 300 (see FIG. 5A). However, secondary stationary disc assembly 500 is rotated 180 degrees to primary stationary disc assembly 300 during assembly. This means that FIG. 7 essentially provides a rear view to FIG. 5A. Both primary stationary disc assembly 300 and secondary stationary disc assembly 500 interface with indexing pin assembly 400 independently. It should also be observed that each stationary disc sub-assembly 300A in primary stationary disc assembly 300 is positioned in direct opposition to a corresponding stationary disc sub-assembly 300B in secondary stationary disc assembly 500 and vice versa (see FIG. 1). This arrangement allows for all four pivot sub-assemblies 300A and 300B to be equidistant from their corresponding indexing pins located in indexing pin assembly 400. Reference points 501, 502, 503, 504, 505, 506, 507, 300A and 300B in FIG. 7 correlate with reference points 301, 302, 303, 304, 305, 306, 307, 300A and 300B in FIG. 5A respectively.

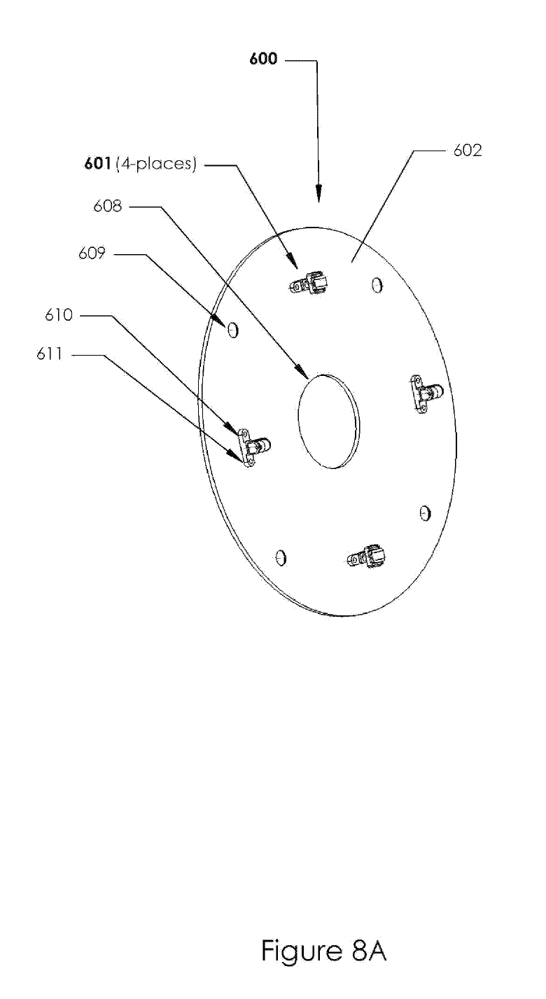

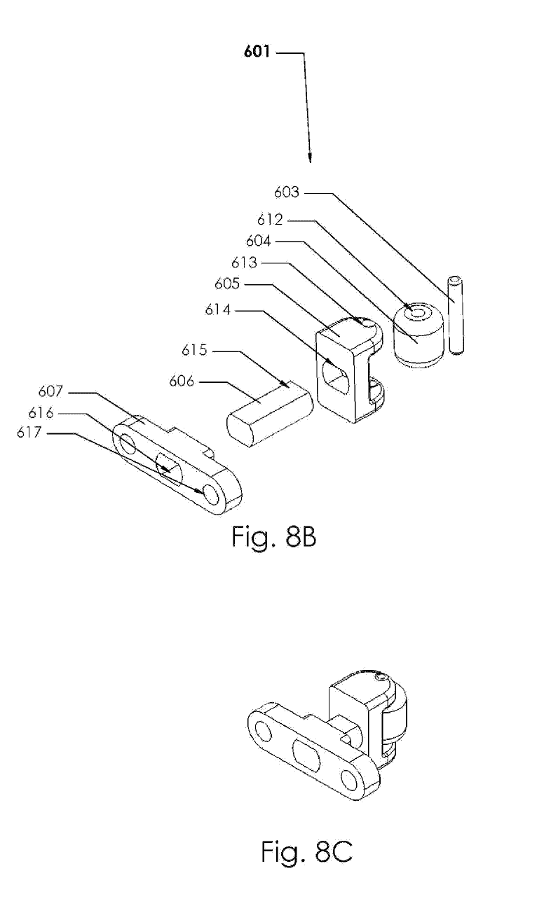

FIG. 8A illustrates a perspective view of transfer disc assembly 600. Transfer disc assembly 600 comprises transfer disc roller sub-assembly 601 (shown 4-places) and transfer disc 602. Transfer disc 602 comprises center bore 608, alignment holes 609 (shown 4-places), roller sub-assembly mounting holes 610 (shown 4-places) and roller sub-assembly mounting holes 611 (shown 4-places). FIG. 8B illustrates the component parts of transfer disc roller sub-assembly 601. Transfer disc roller sub-assembly 601 comprises transfer disc roller pin 603, transfer disc roller 604, transfer disc clevis 605, transfer disc push rod 606 and transfer disc mounting bracket 607. Transfer disc roller 604 includes transfer disc roller pin assembly hole 612, transfer disc clevis 605 includes transfer disc clevis roller pin mounting holes 613 and transfer disc clevis push rod hole 614, transfer disc push rod comprises transfer disc push rod alignment flats 615 (2 shown) and, transfer disc mounting bracket 607 includes transfer disc mounting bracket push rod hole 616, and transfer disc bracket mounting holes 617 (shown-2 places).

FIG. 8C illustrates an assembled view of transfer disc roller sub-assembly 601. It should be noted that the distance between transfer disc mounting bracket holes 617 (shown 2-places) is a match to the distance between roller sub-assembly mounting holes 610 and 611 respectively (see FIG. 8A). Transfer disc roller sub-assemblies 601 are fixedly attached to transfer disc 602 via rivets, screws, bonding agents or other bonding mechanisms.

FIG. 9 illustrates a perspective view of a secondary rotating disc assembly 700. Secondary rotating disc assembly 700 comprises components similar to and is essentially identical to primary rotating disc assembly 200 (see FIG. 4). However, secondary rotating disc assembly 700 is rotated 180 degrees to primary rotating disc assembly 200 during assembly. This means that FIG. 9 essentially provides a rear view to FIG. 4. Moveable disc 701, indexing rod roller 703, indexing rod section 704, center bore 706, moveable disc slots 708, roller access hole 710 and indexing rod roller slot 711 correlate with moveable disc 201, indexing rod roller 203, indexing rod section 204, center bore 206, moveable disc slots 208, roller access hole 210 and indexing rod roller slot 211 respectively. Indexing rod section 704 interfaces with indexing rod access hole 143 of inner hinge section 102 (see FIG. 3B) in the same manner as does indexing rod section 204 (see FIG. 4) with access hole 127 of outer hinge section 101 (see FIG. 2B). References corresponding to those viewable in FIG. 4 that are not viewable in FIG. 9 include lifter ramp 702, stiffening rim 705, lifter ramp plateau 707 and tapered ramp section 709.

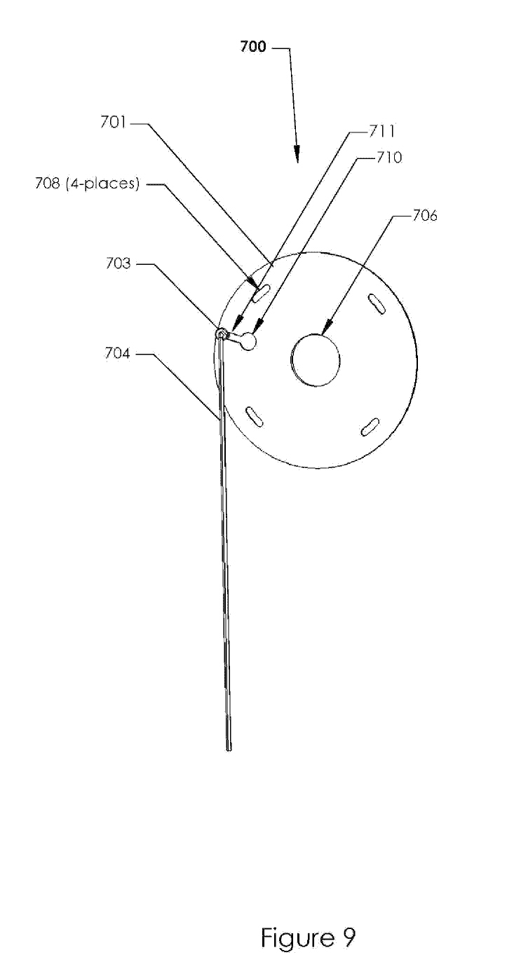

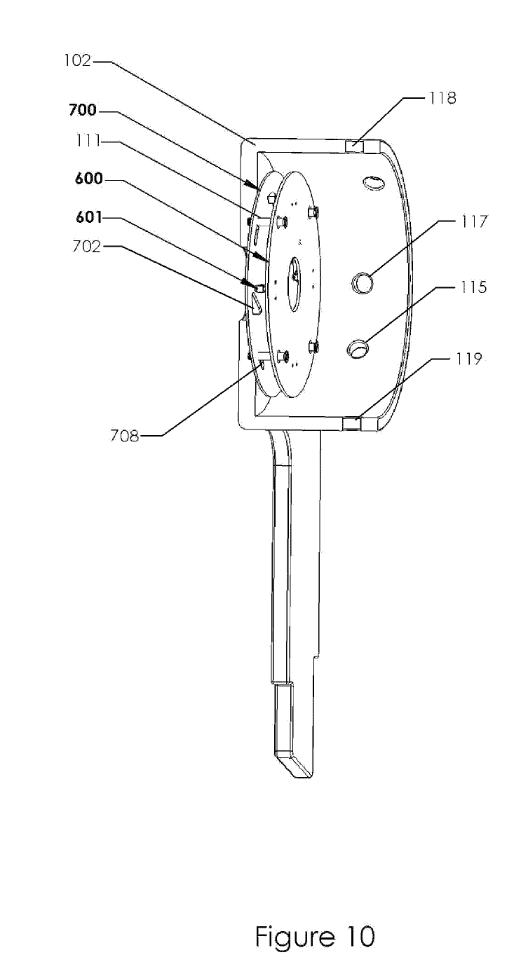

FIG. 10 illustrates a sectioned internal view of outer hinge section 102 in its assembled relation to secondary rotating disc assembly 700 and transfer disc assembly 600. Also shown in this illustration are outer retaining screw 111 (one of four shown) (see also FIG. 1), moveable disc slot 708 (1 of 4 shown), lifter ramp 702 (one of four shown) (see also FIG. 4) and transfer disc roller sub-assembly 601 (one of four shown) (see also FIG. 8A). Additionally shown are indexing holes 115 and 117 and sectioned indexing holes 118 and 119 (see also FIG. 2A). In this illustration it is apparent that indexing holes 115 and 117 are on a different bolt circle diameter than indexing holes 118 and 119. It is made most apparent by observing the tear-out (distance between a hole and the nearest edge of outer shell 113. Further shown in this illustration is the assembled relation of outer retaining screw 111 to transfer disc assembly 600 and moveable disc slot 708 of secondary rotating disc assembly 700. Here it can be seen that as secondary rotating disc assembly 700 is rotated in a clockwise direction as viewed in this illustration, moveable disc slots 708 (one of four shown) provide clearance for outer retaining screw 111 (one shown to represent all outer retaining screws 111 employed). It can also be seen in this illustration that retaining screw 111 provides both a rotational restraint that prohibits transfer disc assembly 600 from rotating in either a clockwise or counter clockwise direction with respect to outer hinge section 102 while at the same time allowing transfer disc assembly 600 to slidably move inward and outward with respect to the axis of hinge master assembly 100.

FIG. 11 illustrates a sectional internal view of inner hinge section 101 in its assembled relation to primary rotating disc assembly 200, primary stationary disc assembly 300, indexing pin assembly 400 and secondary stationary disc 500. Also shown in this illustration are master pin 103 and master pin retainer 104 in their respective positions relative to the overall assembly. Additionally shown are inner retaining screws 107 (one of four shown), rotating disc slot 208 (one of four shown), and tapered ramp section 209 (one of four shown). Further shown are hub extension 422 (one of two shown) and indexing pin 401. As can be observed in this illustration, inner retaining screws 107 (four shown) pass through mounting holes 504 of secondary stationary disc 501, past indexing pin assembly 400, through mounting holes 304 of primary stationary disc 301, through moveable disc slots 208 of primary rotating disc assembly 200 and into attachment holes 141 of inner hinge section 102 (see FIG. 3A). As can also be observed, primary stationary disc assembly 300 and secondary stationary disc assembly 500 are pressed or otherwise fixedly attached to hub extensions 422 (one of two shown) of index pin locator bushing 402 (see FIGS. 6A, 6B and 6C).

As indexing rod section 204 is pulled downward, primary rotating disc assembly 200 pivots with respect to inner hinge section 101 about master pin 103 within the limits defined by the moveable disc slots 208 (one of four shown) and inner retaining screws 107 (one of four shown). As primary rotating disc assembly 200 pivots, it draws the tapered ramp sections 209 beneath the rollers 314 of pivot assemblies 300A and 300B thereby pushing the pivot assemblies toward the center of the hinge and causing pivots 307 (see FIG. 5C) to rotate as illustrated in FIGS. 5D, 5E and 5F. As pivots 307 thus rotate they enter the indexing pin slots 409 of the indexing pins 401 pushing each surface 318 (see FIGS. 5D and 5F) against the indexing balls 403 of each index pin sub-assembly 400A (see FIGS. 6D and 6E). Indexing ball spring 404 affords just enough pressure against indexing ball 403 to allow indexing ball 403 to roll freely against pivot pushing surface 318. Thus, the indexing balls 403 and indexing ball springs 404 are one example of an indexing-pin means or structure for engaging the pivots 307. Another example of a simpler structure that may, however, be prone to faster wear is a simple cavity, spring, or other moveable or non-moveable, non-rolling surface within the indexing pin slots 409.

As each pivot 307 continues to rotate against its corresponding indexing ball 403, the entire index pin sub-assembly 400A is also pushed toward the axis of rotation of hinge master assembly 100 (see FIG. 1) until each index pin 401 disengages from the outer hinge section 102. As can be seen, this process acts upon all four index pin sub-assemblies 400A of indexing pin assembly 400 simultaneously (see FIGS. 6A and 6B). This enables outer hinge section 102 to pivot about inner hinge section 101 freely. As the downward force against indexing rod section 204 is released, moveable disc 201 returns to its original position thereby releasing the force against pivot assemblies 300A and 300B (see FIG. 5A). This in turn releases the force against the index pin sub-assemblies 400A thereby allowing indexing pin retainer springs 407 to exert an outward pressure against all index pin sub-assemblies 400A. As outer hinge section 102 is further rotated about inner hinge section 101, the first indexing pin sub-assemblies 400A that align with any of the indexing holes in outer hinge section 102 will be pushed outward by the indexing pin retainer springs 407 and into these indexing holes thereby engaging outer hinge section 102 with inner hinge section 101.

Similarly, as indexing rod section 704 is pulled downward (returning to the view of FIG. 10), secondary rotating disc assembly 700 pivots with respect to outer hinge section 102 about master pin 103 within the limits defined by the moveable disc slots 708 (one of four shown) and outer retaining screws 111 (one of four shown). As secondary rotating disc assembly 700 pivots, it draws the tapered ramp sections of lifter ramps 702 beneath the rollers of transfer disc roller sub-assemblies 601 thereby pushing the transfer disc assembly 600 toward the center of the hinge master assembly 100. The inward movement of the transfer disc assembly 600 causes the transfer disc 602 to press against the rollers 314 of pivot assemblies 300A and 300B of the secondary stationary disc assembly 500, moving said pivot assemblies 300A and 300B toward the center of the hinge master assembly 100 and causing pivots 307 (see FIG. 5C) to rotate as illustrated in FIGS. 5D, 5E and 5F. The transfer disc assembly 600 therefore allows movement of the indexing rod section 704 to cause movement of the pivot assemblies 300A and 300B of the secondary stationary disc assembly 500 regardless of the relative rotational orientation of the outer hinge section 102 with respect to the inner hinge section 101.

As the pivots 307 of the secondary stationary disc assembly 500 rotate, they enter the indexing pin slots 409 of the indexing pins 401 (from the opposite side of the indexing pins 401 as the pivots 307 of the primary stationary disc assembly 300) pushing each surface 318 (see FIGS. 5D and 5F) against the indexing balls 403 of each index pin sub-assembly 400A (see FIGS. 6D and 6E). Indexing ball spring 404 affords just enough pressure against indexing ball 403 to allow indexing ball 403 to roll freely against pivot pushing surface 318.

As each pivot 307 continues to rotate against its corresponding indexing ball 403, the entire index pin sub-assembly 400A is also pushed toward the axis of rotation of hinge master assembly 100 (see FIG. 1) until each index pin 401 disengages from the outer hinge section 102 as discussed above, allowing rotation of the outer hinge section 102 with respect to the inner hinge section 101. As the downward force against indexing rod section 704 is released, moveable disc 701 returns to its original position thereby releasing the force against the transfer disc assembly 600 and thereby the force against the pivot assemblies 300A and 300B of the secondary stationary disc assembly 500, allowing the indexing pins sub-assemblies 400A to engage indexing holes and re-lock the hinge master assembly 100 as discussed above.

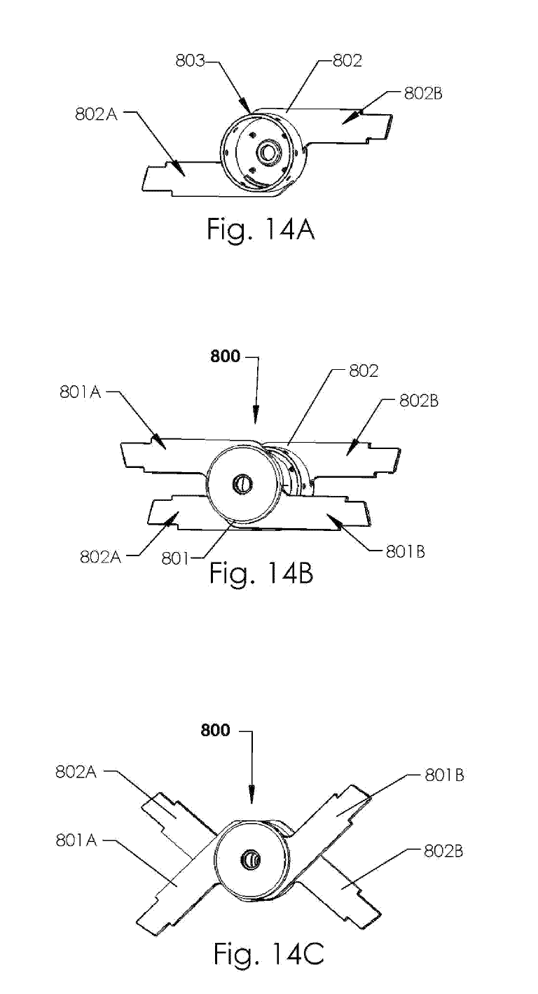

Thus, the hinge master assembly 100 may be disengaged to allow rotation (e.g. opening and/or closing) from either side of the hinge master assembly 100, which may, of course, enhance usability of the hinge master assembly 100 for ladders and the like. In some instances, it may not be necessary to allow actuation of the hinge master assembly 100 from both sides. For example, where an embodiment of the hinge master assembly 100 is to be used for items such as scaffolding as discussed with respect to FIGS. 14A-14C, it may be satisfactory to allow operation of the hinge master assembly 100 from a single point or hinge extension. In such a case, it will be appreciated that the secondary stationary disc assembly 500, the transfer disc assembly 600, the secondary rotating disc assembly 700 and their corresponding parts and components may be omitted.

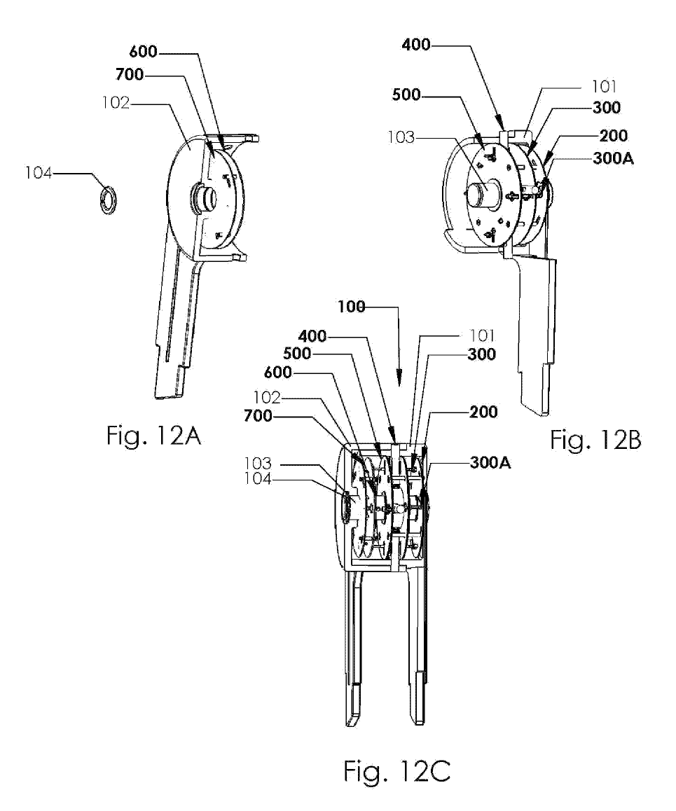

FIG. 12A illustrates a sectioned perspective view of outer hinge section 102 of hinge master assembly 100 in its relative position with respect to inner hinge section 101 of hinge master assembly 100. Herein it may be observed that the center bore of master pin retainer 104 is aligned with the center bores of outer hinge section 102, transfer disc assembly 600 and secondary rotating disc assembly 700.

FIG. 12B illustrates a sectioned perspective view of inner hinge section 101 of hinge master assembly 100 in its relative position with respect to outer hinge section 102 of hinge master assembly 100. Herein it may be observed that master pin 103 is aligned with the center bores of inner hinge section 101, primary rotating disc assembly 200, primary stationary disc assembly 300, indexing pin assembly 400 and secondary stationary disc assembly 500.

FIG. 12C illustrates a sectioned perspective view of master hinge assembly 100. Herein it may be observed that master pin retainer 104 is engaged with master pin groove 151 (see FIG. 11) of master pin 103 thereby locking inner hinge section 101 to outer hinge section 102 allowing the two sections to rotate only with respect to each other. Master pin retainer 104 includes master pin retainer slot 152 (see FIG. 11) that allows it to expand as it is being pressed onto master pin 103 until it is aligned with master pin slot 151 where it snaps into the said master pin slot 151 thereby locking it into place. This comprises the entire assembly of hinge master assembly 100.

It should be noted that the overall thickness of hinge master assembly 100 may be coordinated with the overall thickness of a ladder rail or scaffold lattice section so as to make the outer surfaces of hinge master assembly 100 sub stantialy co-planar with the outer surfaces of the said ladder rail or scaffold lattice section. In this manner the described surfaces blend with each other so as to have a smooth transition between the corresponding surfaces thereby eliminating any potential for hanging up with any wires, cables or electrical lines with which the assembly comes in contact.

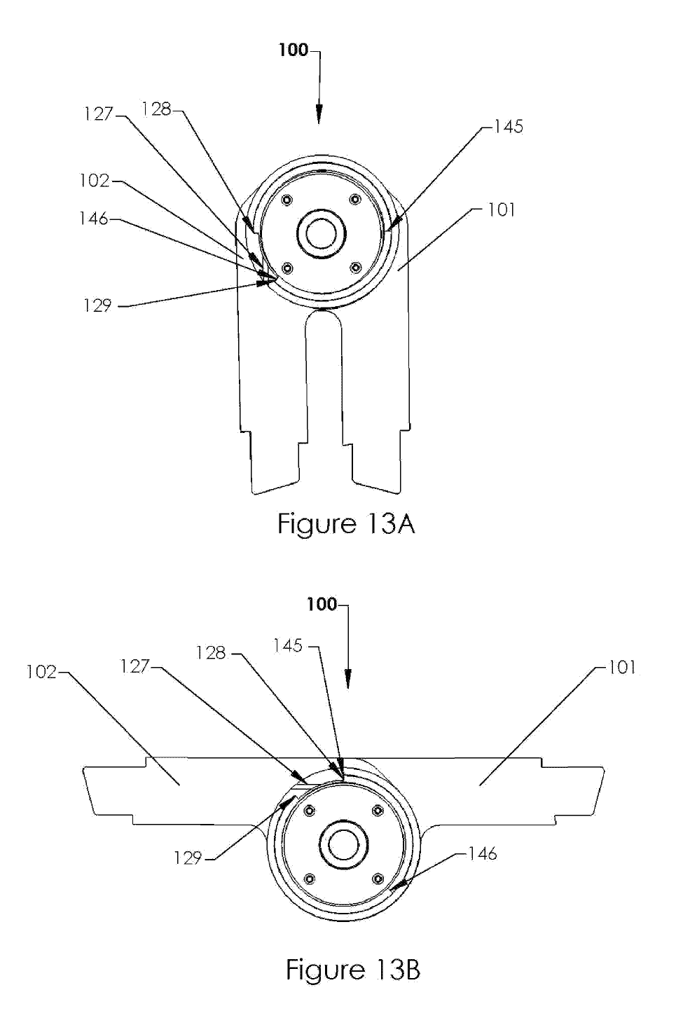

FIG. 13A illustrates a sectioned perspective view of hinge master assembly 100 wherein all internal parts are removed and the frontal face of inner hinge section 101 is sectioned off to a depth that exposes the relationship between the positive stops in both the inner hinge section 101 and outer hinge section 102. As herein illustrated the assembly is in its closed position. In this position closed interior stop face 129 of outer hinge section 102 (see FIG. 2A) abuts against closed exterior stop face 146 thereby prohibiting hinge master assembly 100 from closing any further. At this point it may be observed that open interior stop face 128 of outer hinge section 102 (see FIG. 2A) is located 180 degrees from open exterior stop face 145 of inner hinge section 101 (see FIG. 3A). Also in the closed position the associated indexing pins 401 are aligned between both hinge sections 101, 102 so as to lock the hinge master assembly 100 into this position until re-actuated.

FIG. 13B also illustrates a sectioned perspective view of hinge master assembly 100 wherein all internal parts are removed and the frontal face of inner hinge section 101 is sectioned off to a depth that exposes the relationship between the positive stops in both the inner hinge section 101 and outer hinge section 102. In this illustration the hinge master assembly 100 is in its open position. In this position open interior stop face 128 of outer hinge section 102 abuts against open exterior stop face 145 of inner hinge section 101 thereby prohibiting hinge master assembly 100 from opening any further. At this point it may be observed that closed interior stop face 129 of outer hinge section 102 is now 180 degrees from closed exterior stop face 146 of inner hinge section 101. Again, in this position the associated indexing pins 401 are aligned between both hinge sections 101, 102 so as to lock the hinge master assembly 100 into this position until re-actuated. Also visible in both FIGS. 13A and 13B is a sectioned view of indexing rod access hole 127, exposed when the frontal face of inner hinge section 101 was sectioned away to expose the stops in both hinge sections 101 and 102.

In an alternative embodiment illustrated in FIGS. 14A-14C, hinge master assembly 800 comprises an inner hinge section 801 and an outer hinge section 802. Inner hinge section 801 is largely similar to inner hinge section 101 with the exception that inner hinge section 101 comprises a single inner hinge extension 147 whereas inner hinge section 801 comprises two hinge extensions 801A and 801B. Hinge extension 801A of inner hinge section 801 is largely similar to hinge extension 147 of inner hinge section 101. Hinge extension 801B, however, is positioned approximately 180 degrees about the center axis of inner hinge section 801.

FIG. 14A illustrates a frontal interior perspective view of outer hinge section 802 of hinge master assembly 800 wherein two hinge extensions, 802A and 802B, extend from and are asymmetrically positioned approximately 180 degrees from each other about an outer shell 803. As typically applied, for example, to collapsible scaffolding, this arrangement allows for two sections of scaffold extensions to be attached to the same hinge section while remaining parallel to each other and in the same plane.

FIG. 14B illustrates a perspective view of hinge master assembly 800 in its closed position. Herein outer hinge section 802 is diametrically opposed to inner hinge section 801 wherein all four hinge extensions 801A, 801B, 802A and 802B are approximately parallel to each other. In this position all scaffold extensions that may be attached to each of the hinge extensions would also be approximately parallel to each other and the corresponding scaffold would be in a “collapsed” position.

FIG. 14C illustrates a perspective view of hinge master assembly 800 in an opened position. Herein it may be observed that master hinge assembly 800 opens and closes in a scissor-like fashion; that is, as hinge extension 802A moves downward hinge extension 802B correspondingly moves upward. Likewise, as hinge extension 801B moves downward hinge extension 801A correspondingly moves upward. When these movements are applied to a scaffold, they transpire simultaneously.

It should be noted that the internal stops in hinge master assembly 800 may be re-designed to fit the needs of the device to which it is being applied. Additionally, the indexing pins and corresponding indexing holes may also be relocated to meet a specific application. In addition, specific modifications will enable the forgoing embodiments to be applied to military launch beams, temporary bridges, temporary wall or ceiling supports and various other applications.

The present invention may be embodied in other specific forms without departing from the spirit or essential characteristics. The described embodiments are to be considered in all respects only as illustrative and not restrictive. The scope of the invention is, therefore, indicated by the appended claims rather than by the foregoing descriptions. All changes which come within the meaning and range of equivalency of the claims are to be embraced within their scope.

What is claimed and desired to be secured by a United States Letters Patent is:

1. An articulating hinge, comprising:
A) a first inner hinge section comprising:
i) a cup shaped body section, and,
ii) at least one indexing hole in the peripheral surface of the cup-shaped area, and,
iii) one extended section extending from the peripheral surface of the cup-shaped area, and,
iv) one center bore to facilitate assembly of the articulating hinge, and,
v) at least one mounting hub in the bottom surface of the cup-shaped area, and,
vi) a first rod access hole to allow for a first actuator rod to extend through the peripheral surface of the cup-shaped area, and,
B) a first outer hinge section comprising:
i) a cup shaped body section comprising a slip-fit relationship over a part of the peripheral surface of the cup shaped body as described in claim 1)A)i) and,
ii) at least two indexing holes separated from each other by a prescribed radial distance and aligned in the same plane as the indexing hole described in claim 1)A)ii) when the articulating hinge is fully assembled, and,
iii) one extended section extending from the peripheral surface of the cup-shaped area, and,
iv) one center bore to facilitate assembly of the articulating hinge, and,
v) at least one mounting hub in the bottom surface of the cup-shaped area to facilitate assembly and alignment of associated interior parts, and,
vi) one rod access hole to allow for an actuator rod to extend through the peripheral surface of the cup-shaped area, and,
C) a means for attaching the first inner inner hinge section as described in claim 1)A) to the first outer hinge section as described in claim 1)B), comprising:
i) a first center pin that passes through the center bores of both hinge sections as described in claim 1)A)iv) and claim 1)B)iv), and,
ii) a center pin as described in the forgoing claim having a means for restraining one end thereof from passing through the center bore of a first inner hinge section as described in claim 1)A)iv) and comprising an end cap or head, and,
iii) a center pin as described in the forgoing claim having a means for restraining a second end thereof from being retracted through a first outer hinge section as described in claim 1)B)iv), comprising a slot or groove into which a snap ring or equivalent fastening device may be attached, and,
iv) a fastening device as described in claim 1)C)iii, and,
D) a means for indexing the first inner and outer hinge sections, comprising:
i) at least one indexing pin, and,
ii) at least one return spring for each indexing pin, and,
E) a means for maintaining alignment of the indexing pin described in claim 1)D)i), comprising:
i) an irregular shaped end that is attached to or is part of each of the indexing pins described in claim 1)D)i), and,
ii) a rigid, stationary hub or other object containing a slip-fit hole or holes to match the irregular shaped ends of each of the indexing pins described in the foregoing claim and causing the said pin or pins to recede into or pass through said holes, and,
F) a means for retracting the indexing pin described in claim 1)D)i) from engagement with the indexing holes located in the first inner hinge section described in claim 1)B)ii), comprising:
i) an access slot extending through the side of the indexing pin described in claim 1)D)i), and,
ii) an internal bore with a radial end that intersects the access slot described in claim 1)F)i) in such a manner as to restrict a spherical object (such as a bearing) from extending far enough into the slot to expose more than is required for operation, and,
iii) a spherical object or bearing as described in claim 1)F)ii) that has a slip fit with respect to the internal bore also described in claim 1)F)ii), and,
iv) a bearing return spring that has a slip-fit relationship with the internal bore described in claim 1)F)ii) and exerts a prescribed tension against the spherical object as described in claim 1)F)iii) when a spring retainer is installed, and,
v) a bearing return spring retainer as described in claim 1)F)v) that is fixedly attached to or part of the index pin described in claim 1)D)i), and,
vi) an indexing pin return spring(s) that maintains a relatively constant pressure between the indexing pin(s) as described in claim 1)D)i) and the stationary hub or other centering object as described in claim 1)E)ii) causing the indexing pin(s) to locate into the indexing holes of the second cup shaped body section as described in claim 1)A)ii) when the indexing holes of both the first inner and first outer hinge sections are aligned, and,
G) a means for restricting the outward motion of the indexing pin(s) as described in claim 1)F)vi) so as to inhibit the said pin(s) from protruding past the outer peripheral surface of the cup shaped area of the first outer hinge section as described in claim 1)B), comprising:
i) a roll pin, snap ring or the equivalent attached to each index pin described above and installed at a prescribed distance near the outer end of said index pins in such a position as to bottom out against the inner wall of the cup shaped body section of the first inner hinge section described in claim 1)a) thereby stopping the pin at the prescribed location, and,
H) a means by which the extended end(s) of the index pin(s) described in claim 1)D)i) may be flush with the peripheral surface of the cup-shaped area of the first outer hinge section described in claim 1)A), comprising:
i) a radius formed on the outward end of the index pin(s) described in claim 1)D)i), and,
ii) the radius described in the foregoing claim is so formed as to be equivalent to the peripheral radius of the first outer hinge section described in claim 1)B) and coordinated with the means for restricting the outward motion of the indexing pin(s) as described in claim 1)F)vii) so as to make the outward surface of the indexing pin(s) flush with the peripheral surface of the second hinge section, and,
I) a first means for actuating the indexing pin(s) as described in claim 1)D)i) so as to retract said pin(s) in accordance with the descriptions afforded in claim 1)F) comprising:
i) a first pivoting device having two parallel surfaces that allow one tip of the device to rotate into a first side of the access slots described in claim 1)F)i) of the indexing pins described in claim 1)D)i) and push inward against the bearings described in claim 1)F)iii) toward the center of the hinge thereby pushing the said pins inward as well, and,
ii) a pivoting device for each of the indexing pins as described in the foregoing claim having an extended surface that allows for the said pivoting device to roll across the spherical object or bearing also described in the foregoing claim as it pulls the corresponding indexing pin inward with minimal resistance and wear, and,
iii) a pivoting device as defined in the foregoing claim having a pivotal bore around which the pivoting device may rotate and located at a defined distance from the tip of the extended surface as defined in claim 1)I)i), and,
iv) a pivoting device as described in the forgoing claim having an adjacent slot extending away from the pivotal bore also described in the foregoing claim, co-planar with the said pivotal bore and projecting an acute angle of approximately 45 degrees with respect to the extended surface as defined in claim 1)I)ii), and,
J) a means by which the position of the pivotal bore described in claim 1)F)iii) may be stabilized with respect to both the axis of the bore and the lateral displacement of said pivotal bore with respect to the associated index pin comprising:
i) a first stationary disc that is stationary with respect to both a first inner hinge section as described in claim 1)A) and a mounting hub as described in claim 1)B)v), and,
ii) a disc or other device as described in the forgoing claim and having a second mounting hub that is either attached to or formed as an integral part thereof and having a bore therein that matches the pivotal bore as described in claim 1)I)iii), and,
iii) a disc as described in the forgoing claim and having a second mounting hub that is either attached to or formed as an integral part thereof and having an irregularly shaped center bore passing through it, and,
iv) a pivotal pin aligned with the axis of both the pivotal bore described in claim 1)I)iii of the pivoting device described in claim 1)I)ii) and the mounting hub as described in the foregoing claim, and,
v) a pivotal pin as described in the forgoing claim having a slip-fit relationship with the pivotal bore described in claim 1)J)ii and a press-fit relationship with the mounting hub as described in claim 1)I)ii), or,
vi) a pivotal pin as described in the forgoing claim having a press-fit relationship with the pivotal bore described in claim 1)I)iii and a slip-fit relationship with the mounting hub bore described in claim 1)I)iii, and,
K) a means by which a force may be exerted upon the first pivoting device described in claim 1)I)i) in such a manner as to actuate it as described in claim 1)i), comprising:
i) a first push rod(s) having a yoke formed or attached to one end having a slip-fit relationship with the parallel surfaces of the first pivoting device described in claim 1)I)i), and,
ii) a push rod as described in the forgoing claim having a bore passing through the yoke thereof, the yoke being deep enough to allow the bore thereof to be slidably aligned with the slot described in claim 1)I)iv) without any interference with the pivoting device described above, and,
iii) a push rod(s) as described in the forgoing claim, passing through the bore described in the foregoing description with a slip-fit and in such a manner as to restrict the position and movement of the said rod to a single line of motion, and,
iv) a push rod(s) as described in the forgoing claim having a roller or other low-friction tip at the end opposite the yoke described therein that is capable of sliding or rolling against the motion of a rotating radial surface, and,
L) a first means for exerting a linear force upon the push rod(s) described above, comprising:
i) a first rotating disc having one ramp for each push rod employed and having the said ramps attached or integrally formed with the said disc, and,
ii) a rotating disc as described in the foregoing claim having the said ramps arranged in a circular pattern in such a manner as to draw each ramp beneath each mated roller as the disc is rotated, and,
M) a means for rotating the disc described in the foregoing claim comprising:
i) a first actuator rod as described in claim 1)A)vi) extending through the access hole of the first inner hinge section described in claim 1)A), and,
ii) an actuator rod as described in the foregoing claim having a tip bent to an angle of approximately 90 degrees and extending to a prescribed length, and,
iii) a first indexing rod roller having a bore into which the bent tip of the actuator rod described in the foregoing claim is inserted and has a slip-fit relationship with the said actuator rod, and,
iv) an indexing rod roller having a slot or groove in the periphery thereof, and,
v) an indexing rod roller slot in the rotating disc described in claim 1)L)i) that extends from a prescribed position from the center of the said disc outward to a position near the periphery of the said disc and having a width that allows for a slip-fit with respect to the indexing rod roller described in the foregoing claim, and,
vi) a first indexing rod roller slot in the first rotating disc described in the foregoing claim and having a first access bore at the inner end of the slot that allows the indexing rod roller to freely enter until the groove of the roller aligns with the indexing rod roller slot described in the foregoing claim, and,
N) a second means for actuating the indexing pin(s) described in claim 1)d)i) so as to retract said pin(s) in accordance with the descriptions afforded in claim 1)f) comprising:
i) a second pivoting device having two parallel surfaces that allow one tip of the device to rotate into a second side of the access slots described in claim 1)f)i) of the indexing pins described in claim 1)d)i) and push inward against the bearings described in claim 1)f)iii) toward the center of the hinge thereby pushing the said pins inward as well, and,
ii) a second pivoting device for each of the indexing pins as described in the foregoing claim having an extended surface that allows for the said pivoting device to roll across the spherical object or bearing also described in the foregoing claim as it pulls the corresponding indexing pin inward with minimal resistance and wear, and,
iii) a pivoting device as defined in claim 1)I)ii) having a pivotal bore around which the pivoting device may rotate and located at a defined distance from the tip of the extended surface as also defined in claim 1)I)ii), and,
iv) a second pivoting device as described in claim 1)I)iv) having an adjacent slot extending away from the pivotal bore described in the foregoing claim, co-planar with the said pivotal bore and projecting an acute angle of approximately 45 degrees with respect to the to the extended surface as defined in claim 1)I)ii), and,
O) a means by which the position of the pivotal bore described in claim 1)I)iii) may be stabilized with respect to both the axis of the bore and the lateral displacement of said pivotal bore with respect to the associated index pin comprising:
i) a second disc that is stationary with respect to both a second inner hinge section as described in claim 1)A) and a stationary hub as described in claim 1)A)v), and,
ii) a disc as described in the forgoing claim and having a first mounting hub that is either attached to or formed as an integral part thereof and having a bore therein that matches the pivotal bore as described in claim 1)I)iii), and,
iii) a disc as described in the forgoing claim and having a second mounting hub that is either attached to or formed as an integral part thereof and having an irregularly shaped center bore passing through it, and,
iv) a pivotal pin aligned with the axis of both the pivotal bore described in claim 1)I)iii) and the mounting hub as described in the foregoing claim, and,
v) a pivotal pin as described in claim 1)I))iii) having a slip-fit relationship with the pivotal bore described in claim 1)I)iii) and a press-fit relationship with the mounting hub as described in claim 1)I)ii), or,
vi) a pivotal pin as described in claim 1)I)iii having a press-fit relationship with the pivotal bore described in claim 1)I)iii) and a slip-fit relationship with the mounting hub bore described in claim 1)I)iii) and a slip-fit relationship with the mounting hub described in claim 1)I)ii), and,
P) a second means by which a force may be exerted upon a second pivoting device described in claim 1)I)i) in such a manner as to actuate it as described in claim 1)I), comprising:
i) a second push rod(s) having a yoke formed or attached to one end having a slip-fit relationship with the parallel surfaces of the first pivoting device described in claim 1)I)i), and,
ii) a push rod as described in the forgoing claim having a bore passing through the yoke thereof, the yoke being deep enough to allow the bore to be slidably aligned with the slot described in claim 1)I)iv) without interference with the pivoting device described above, and,
iii) a push rod as described in the forgoing claim, passing through the bore described in the foregoing description with a slip-fit and in such a manner as to restrict the position and movement of the said rod to a single line of motion, and,
iv) a push rod(s) as described in claim 1)K)iv) having a roller or other low-friction tip at the end opposite the yoke described therein that is capable of sliding or rolling against the motion of a radial surface, and,
Q) a means for exerting a force upon the push rod(s) described in claim 1)K)iv), comprising:
i) a transfer disc having a radial surface as described in the foregoing claim that is either parallel to or tangent to the roller s or other low-friction tips also described in the foregoing claim, and,
ii) a transfer disc as described in the foregoing claim that has a first surface that is capable of rotating freely along the center pin described in claim 1)C)i) but is restricted from having any rotary motion about the same center pin, and,
iii) a transfer disc as described in the foregoing claim having a set of rollers mounted to a second side thereof that are radially disbursed at a radius equivalent to that of the ramps of the rotating disc described in claim 1)L)i) and having the radii of the said rollers co-incident with the radius of ramp disbursement described above, and,
R) a means for exerting a linear force upon the set of rollers described in the foregoing claim comprising:
i) a second rotating disc having one ramp for each push rod employed and having said ramps attached or integrally formed with the said disc, and,
ii) a rotating disc as described in the foregoing claim having the said ramps arranged in a circular pattern in such a manner as to draw each ramp beneath each mated roller as the disc is rotated, and,
S) a means for rotating the disc described in the foregoing claim comprising:
i) a second actuator rod as described in claim 1)M) extending through the access hole of the first outer hinge section described in claim 1)B)vi), and,
ii) an actuator rod as described in the foregoing claim having a tip bent to an angle of approximately 90 degrees and extending to a prescribed length, and,
iii) a second indexing rod roller having a bore into which the bent tip of the actuator rod described in the foregoing claim is inserted and has a slip-fit relationship with the said actuator rod, and,
iv) a second indexing rod roller having a slot or groove in the periphery thereof, and,
v) an indexing rod roller slot in the second rotating disc described in claim 1)M)v) that extends from a prescribed position from the center of the said disc outward to a position near the periphery of the said disc and having a width that allows for a slip-fit with respect to the indexing rod roller described in the foregoing claim, and,
vi) an indexing rod roller slot in the rotating disc described in the foregoing claim and having an access bore at the inner end of the slot that allows the indexing rod roller to freely enter until the groove of the roller aligns with the indexing rod roller slot described in the foregoing claim, and,
T) a means for providing dead stops within the articulating hinge assembly that limit the scope of radial movement to a maximum location that corresponds with the full-opened position of the hinge and to a minimum location that corresponds with the full-closed position, comprising:
i) a raised section within the base portion of the cup-shaped section of the outer hinge section as described in claim 1)B)i) that extends inward from the inner surface of the peripheral shell of the said cup-shaped section to a prescribed distance within the shell and is radially limited to a prescribed section thereof, and,
ii) a recessed section within the rim of the cup-shaped area of the inner hinge section as described in claim 1)A)i) that extends radially within a prescribed range thereof.

2. An articulating hinge as recited in claim 1, comprising:
A) a second inner hinge section as described in claim 1)A), having:
i) at least one additional indexing hole in the peripheral surface of the cup-shaped area and located in at least one radial plane that is parallel to and displaced from the radial plane in which the indexing hole(s) described in claim 1)A)ii) are located, and,
B) a second outer hinge section as described in claim 1)B), having:
i) at least two indexing holes separated from each other by a prescribed radial distance and aligned in the same plane as the indexing hole described in the foregoing claim, and,
C) a means for attaching the second inner hinge section as described in claim 2)A) to the second outer hinge section as described in claim 2)B), in a manner as described in claim 1)C), and,
D) a means for indexing the second inner hinge section and the second outer hinge section described in the forgoing claim in a manner as described in claim 1)D), and,
E) a means for maintaining alignment of the indexing pin(s) described in the forgoing claim and as described in claim 1)E), and,
F) a means for retracting the indexing pin(s) described in the forgoing claim from engagement with the indexing holes located in the second inner hinge section described in claim 2)B) and in a manner as described in claim 1)F), and,
G) a means for restricting the outward motion of the indexing pin(s) described in the forgoing claim and in a manner as described in claim 1)G), and,
H) a means by which the extended end of the index pin(s) described in the forgoing claim may be flush with the peripheral surface of the cup-shaped area of the second outer hinge section described in claim 2A) and in a manner as described in claim 1A), and,
I) a means for actuating the indexing pin(s) as described in the forgoing claim and in a manner as described in claim 1)1), and,
J) a means for extending the position of the pivotal bore described in claim 1)I)3) by a distance commensurate with the displacement of the indexing hole(s) as described in claim 2)A)i), comprising:
i) an extended yoke as described in claim 1)K)i) that places the bore thereof in the prescribed position, and,
ii) an extended push rod as described in claim 1)K)i) that places the bore described in the forgoing claim in the prescribed position, or,
iii) a spacer inserted between the yoke described in claim 1)K)i) and the stationary disc to which it is attached, and,
K) a second means for providing dead stops within the articulating hinge assembly as described in claim 1)T).

3. An articulating hinge as described in claim 1, comprising:
A) a third inner hinge section as described in claim 1)A), having a second extended section as described in claim 1) A)iii) radially displaced from the first extended section by 180 degrees about the center axis of the said hinge section and in the same plane, and,
B) a third outer hinge section as described in claim 1)B), having a second extended section as described in claim 1)B)iii) radially displaced from the first extended section by 180 degrees about the center axis of the said hinge section and in the same plane, and,
C) a means for attaching the third inner hinge section as described in claim 3)A) to the third outer hinge section as described in claim 3)B), in a manner as described in claim 1)C), and,
D) a second means for providing dead stops within the articulating hinge assembly as described in claim 1)T), comprising:
i) a flat-wound coil spring having one end thereof attached to the inner hinge section of the hinge assembly and the other end attached to the outer hinge section with the spring so wound as to create a positive tension between the two halves in such a manner as to push them apart from each other so as to assist in the opening of a scaffold or similar product.

4. A hinge comprising:
an inner hinge section comprising an approximately-cylindrical outer shell having opposing indexing holes therein;
an outer hinge section comprising an approximately-cylindrical outer shell having opposing indexing holes therein, wherein the outer shell of the outer hinge section is sized to receive the outer shell of the inner hinge section therein;
a rotating disc assembly configured to be disposed within the outer shell of the inner hinge section and to be manipulated by an indexing rod passing through an indexing rod access hole located in one of the inner hinge section and the outer hinge section;
an indexing pin assembly configured to be disposed within the outer shell of the inner hinge section such that indexing pins of the indexing pin assembly are disposed to pass through indexing holes of the inner hinge section and at least partially enter indexing holes of the outer hinge section; and
a stationary disc assembly configured to be disposed within the outer shell of the inner hinge section between the rotating disc assembly and the indexing pin assembly, and wherein the stationary disc assembly is configured to translate rotational motion of the rotating disc assembly into inward radial motion of the indexing pins of the indexing pin assembly.

5. A hinge as recited in claim 4, further comprising a master pin disposed to pass through an axis of rotation of the inner hinge section, the outer hinge section, the rotating disc assembly, the indexing pin assembly, and the stationary disc assembly.

6. A hinge as recited in claim 4, wherein the rotating disc assembly comprises:
a moveable disc;
a plurality of lifter ramps affixed to the moveable disc; and
a plurality of movable disc slots in the moveable disc, each moveable disc slot permitting passage of a retaining fastener therethrough while permitting limited rotational movement of the moveable disc relative to one of the inner hinge section and the outer hinge section.

7. A hinge as recited in claim 6, wherein the stationary disc assembly comprises:
a stationary disc;
a plurality of clearance slots corresponding to the indexing pins; and
a plurality of pivot assemblies, each pivot assembly being associated with and passing through one of the clearance slots to engage one of the lifter ramps as the rotating disc assembly is rotated.

8. A hinge as recited in claim 7, wherein the indexing pin assembly comprises:
a hub with locator holes corresponding to the indexing pins;
a plurality of return springs located within the locator holes; and
a plurality of the indexing pins abutting the return springs within the locator holes, wherein each indexing pin comprises an indexing pin slot configured to receive a portion of a pivot of the pivot assembly whereby the indexing pins can be selectively pushed against a force of their return springs by the pivots and deeper into the locator holes.

9. A hinge as recited in claim 4, wherein the rotating disc assembly is a primary rotating disc assembly and the stationary disc assembly is a primary stationary disc assembly, the hinge further comprising:
a secondary stationary disc assembly configured to be disposed within the outer shell of the inner hinge section opposite of the indexing pin assembly from the primary stationary disc assembly;
a transfer disc assembly configured to be disposed within the outer shell of the inner hinge section adjacent the secondary stationary disc assembly on a side of the secondary stationary disc assembly opposite to the indexing pin assembly; and
a secondary rotating disc assembly configured to be disposed within the outer shell of the inner hinge section adjacent the transfer disc assembly on a side of the transfer disc assembly opposite to the secondary stationary disc assembly.

10. A hinge as recited in claim 9, wherein the secondary stationary disc assembly comprises:
a stationary disc;
a plurality of clearance slots corresponding to the indexing pins; and
a plurality of pivot assemblies, each pivot assembly being associated with and passing through one of the clearance slots of the secondary stationary disc assembly to engage the transfer disc assembly.

11. A hinge as recited in claim 10, wherein the transfer disc assembly is attached to one of the inner hinge section and the outer hinge section so as to rotate with the hinge section to which it is attached while being allowed limited linear motion along a central axis of the hinge and wherein the secondary stationary disc assembly is attached to the opposite hinge section so as to rotate therewith, and wherein the transfer disc assembly comprises:
a transfer disc; and
a plurality of transfer disc roller sub-assemblies, each transfer disc roller sub-assembly being configured to engage a lifter ramp of the secondary rotating disc assembly as the secondary rotating disc assembly is rotated.

12. A ladder comprising a pair of hinges as recited in claim 4.

13. A scaffolding comprising a plurality of hinges as recited in claim 4.

14. A hinge comprising:
an inner hinge section comprising an approximately-cylindrical outer shell having opposing indexing holes therein;
an outer hinge section comprising an approximately-cylindrical outer shell having opposing indexing holes therein, wherein the outer shell of the outer hinge section is sized to receive the outer shell of the inner hinge section therein;
a primary rotating disc assembly configured to be disposed within the outer shell of the inner hinge section and to be manipulated by a primary indexing rod passing through a primary indexing rod access hole located in one of the inner hinge section and the outer hinge section;
an indexing pin assembly configured to be disposed within the outer shell of the inner hinge section such that indexing pins of the indexing pin assembly are disposed to pass through indexing holes of the inner hinge section and at least partially enter indexing holes of the outer hinge section; and
a primary stationary disc assembly configured to be disposed within the outer shell of the inner hinge section between the rotating disc assembly and the indexing pin assembly, and wherein the stationary disc assembly is configured to translate rotational motion of the rotating disc assembly into inward radial motion of the indexing pins of the indexing pin assembly;
a secondary stationary disc assembly configured to be disposed within the outer shell of the inner hinge section opposite of the indexing pin assembly from the primary stationary disc assembly;
a transfer disc assembly configured to be disposed within the outer shell of the inner hinge section adjacent the secondary stationary disc assembly on a side of the secondary stationary disc assembly opposite to the indexing pin assembly; and
a secondary rotating disc assembly configured to be disposed within the outer shell of the inner hinge section adjacent the transfer disc assembly on a side of the transfer disc assembly opposite to the secondary stationary disc assembly and further configured to be manipulated by a secondary indexing rod passing through a secondary indexing rod access hole located in whichever of the inner hinge section and the outer hinge section does not have the primary indexing rod access hole.

15. A hinge as recited in claim 14, wherein the primary rotating disc assembly comprises:
a moveable disc;
a plurality of lifter ramps affixed to the moveable disc; and
a plurality of movable disc slots in the moveable disc, each moveable disc slot permitting passage of a retaining fastener therethrough while permitting limited rotational movement of the moveable disc relative to one of the inner hinge section and the outer hinge section.

16. A hinge as recited in claim 15, wherein the primary stationary disc assembly comprises:
a stationary disc;
a plurality of clearance slots corresponding to the indexing pins; and
a plurality of pivot assemblies, each pivot assembly being associated with and passing through one of the clearance slots to engage one of the lifter ramps as the rotating disc assembly is rotated.

17. A hinge as recited in claim 16, wherein the indexing pin assembly comprises:
a hub with locator holes corresponding to the indexing pins;
a plurality of return springs located within the locator holes; and
a plurality of the indexing pins abutting the return springs within the locator holes, wherein each indexing pin comprises an indexing pin slot configured to receive a portion of a pivot of the pivot assembly whereby the indexing pins can be selectively pushed against a force of their return springs by the pivots and deeper into the locator holes.

18. A hinge as recited in claim 14, wherein the secondary stationary disc assembly comprises:
a stationary disc;
a plurality of clearance slots corresponding to the indexing pins; and
a plurality of pivot assemblies, each pivot assembly being associated with and passing through one of the clearance slots of the secondary stationary disc assembly to engage the transfer disc assembly.

19. A hinge as recited in claim 18, wherein the transfer disc assembly is attached to one of the inner hinge section and the outer hinge section so as to rotate with the hinge section to which it is attached while being allowed limited linear motion along a central axis of the hinge and wherein the secondary stationary disc assembly is attached to the opposite hinge section so as to rotate therewith, and wherein the transfer disc assembly comprises:
a transfer disc; and
a plurality of transfer disc roller sub-assemblies, each transfer disc roller sub-assembly being configured to engage a lifter ramp of the secondary rotating disc assembly as the secondary rotating disc assembly is rotated.

20. A ladder comprising a pair of hinges as recited in claim 14.
